(19) United States
(12) Patent Application Publication
(10) Pub. No.: US 2013/0232172 A1
(43) Pub. Date: Sep. 5, 2013

(54) METHODS AND SYSTEMS FOR MATCHING EXPRESSIONS

(71) Applicant: Brendan Wood, Fredericton (CA)

(72) Inventor: Brendan Wood, Fredericton (CA)

(73) Assignee: salesforce.com, inc., San Francisco, CA (US)

(21) Appl. No.: 13/593,291

(22) Filed: Aug. 23, 2012

Related U.S. Application Data
(60) Provisional application No. 61/605,411, filed on Mar. 1, 2012.

(51) Int. Cl. G06F 17/30

(52) U.S. Cl. 707/780; 707/E17.014

(57) ABSTRACT

Methods and systems are provided for matching expressions to data items. One exemplary method involves identifying a subset of expressions that match data items collectively and then identifying individual data items that match expressions of the subset. In one embodiment, the data items are partitioned into data item subsets, and further subsets of expressions collectively matching the data item subsets are identified. Data items of a respective data item subset are then individually matched to expressions of the respective expression subset that collectively matched that respective data item subset.

### CROSS-REFERENCE TO RELATED APPLICATION(S)

This application claims the benefit of U.S. provisional patent application Ser. No. 61/605,411, filed Mar. 1, 2012, the entire content of which is incorporated by reference herein.

### TECHNICAL FIELD

Embodiments of the subject matter described herein relate generally to computer systems, and more particularly, embodiments of the subject matter relate to methods and systems for efficient expression matching.

### BACKGROUND

With the proliferation of social media technologies, organizations are transitioning from traditional marketing and developing social media marketing strategies to engage consumers, influence public sentiment or otherwise control their brand profile, and/or achieve other objectives. To assess the impact of these marketing strategies and determine what adjustments should be made, it is desirable to monitor and/or measure the social media's response. However, the relatively high frequency and volume of social media content generation makes it difficult to monitor social media and provide feedback to organizations at or near real-time.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a block diagram of an exemplary expression matching system;

FIG. 2 is a flow diagram of an exemplary expression matching process suitable for implementation by the expression matching system of FIG. 1; and

FIG. 3 is a block diagram of an exemplary multi-tenant system suitable for integration with in the expression matching system of FIG. 1 in accordance with one or more embodiments.

### DETAILED DESCRIPTION

Embodiments of the subject matter described herein generally relate to matching expressions to individual data items obtained from third-parties, such as social media websites, networks, and/or systems. As used herein, a data item should be understood as referring to a discrete unit or segment of content, such as a computer data file, that includes or is otherwise associated with one or more strings, characters, symbols, and/or other textual information. In this regard, a data item is not necessarily limited to pure text and may include imagery or the like. For example, a data item may include an image, video, or other content having captions, tags or other textual metadata associated therewith. Depending on the embodiment, a data item could be realized as a post, a message, an article, a tag, a document, or the like that is published or otherwise made accessible on a server or another computer system on a communications network, such as the Internet. As used herein, an expression should be understood as referring to a combination of keywords, terms, characters and/or symbols, which may or may not be joined otherwise concatenated using one or more logical operators, that provide one or more strings of characters or text that may be matched to a data item. In this regard, a data item matches an expression when the data item includes, within its content, the one or more strings of characters or text of an expression and otherwise satisfies the expression (e.g., by not including characters or other text specifically excluded by the expression).

As described in greater detail below, the data items obtained from one or more third-party systems over a network, such as the Internet, are partitioned into individual subsets, and for each individual data item subset, the full set of expressions is matched to the data item subset to identify a subset of expressions that match that data item subset, collectively. Each data item of a data item subset may then be individually compared only to expressions of the expression subset that matches that data item subset, thereby reducing the amount of time and/or computational resources required to match expressions to a data item by avoiding exhaustively matching the full set of expressions to each data item (e.g., by individually comparing each expression for the entire set of expressions to each data item). Furthermore, in some embodiments, the individual data item subsets are iteratively subdivided into additional subsets (alternatively referred to herein as child data item subsets), and the expression subset that matched the partitioned data item subset being compared to the additional child data item subsets to identify further subsets of that expression subset (alternatively referred to herein as child expression subsets) that includes only those expressions that match the respective child data item subsets collectively. The individual data items of a resulting child data item subset may then be individually compared to each expression of the resulting child expression subset that collectively matches that respective child data item subset, thereby reducing the time and/or computational resources required to match expressions when the child expression subset contains fewer expressions than the parent expression subset. The number of partitioning stages for subdividing the data items into subsets may be chosen to achieve a desired reduction in the total number of comparisons between individual data items and individual expressions, and the number of data items contained in the respective subsets of the respective partitioning stages may be optimized to achieve an optimal reduction in the number comparisons between individual data items and individual expressions for that number of partitioning stages, as described in greater detail below.

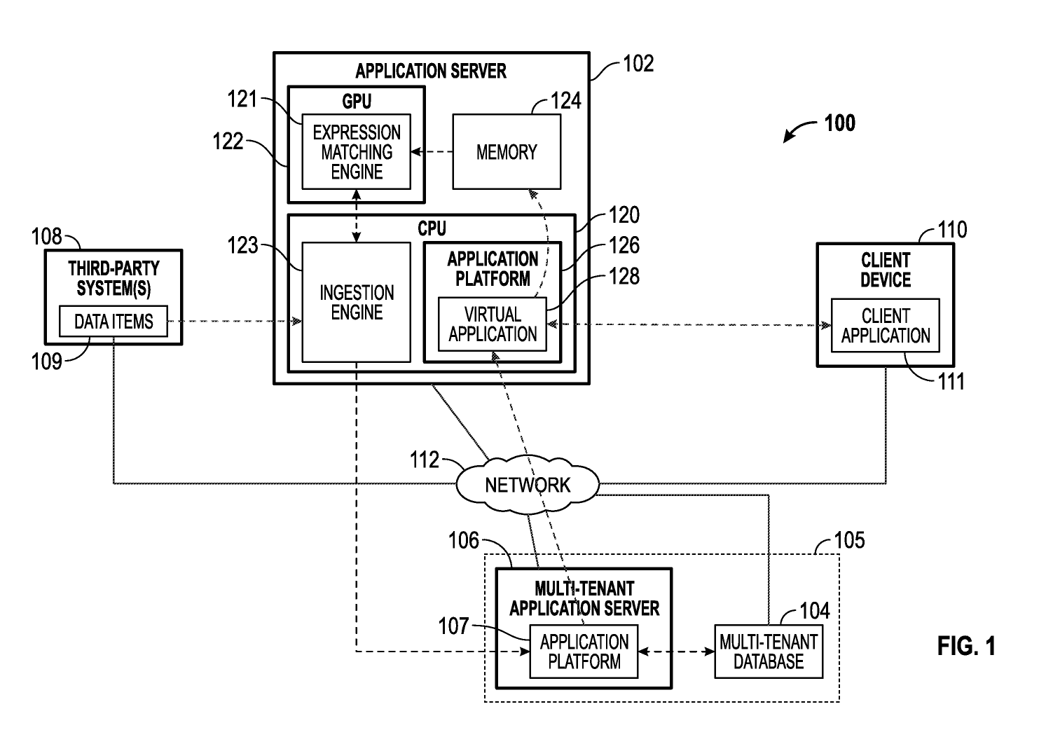

Turning now to FIG. 1, an exemplary expression matching system 100 includes an application server 102 that obtains data items 109 from one or more third-party systems 108 and identifies individual data items 109 that match one or more expressions for further ingestion and/or processing. In exemplary embodiments, the application server 102 stores information pertaining to those matched data items 109 along with their matched expressions in a database 104 that is communicatively coupled to the application server 102 via a communications network 112 such as a wired and/or wireless computer network, a cellular network, a mobile broadband network, a radio network, or the like. It should be understood that FIG. 1 is merely one simplified representation of the expression matching system 100 provided for purposes of explanation and is not intended to limit the subject matter described herein in any way.

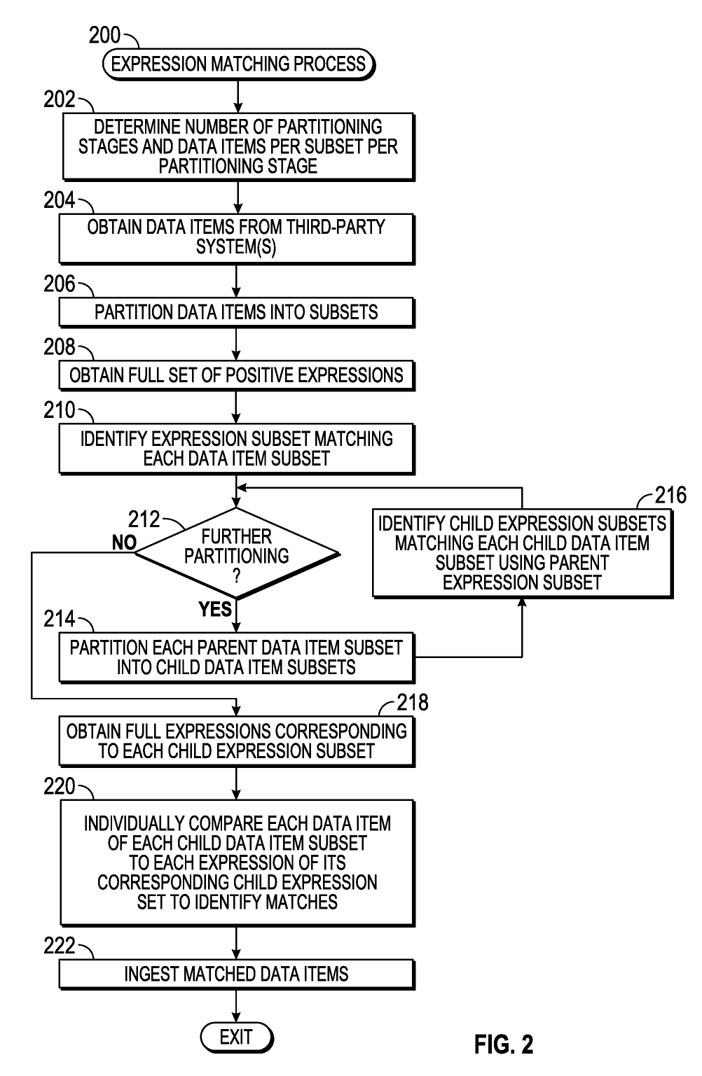

The application server 102 generally represents a computing system or another combination of processing logic, circuitry, hardware, and/or other components that is coupled to the network 112 and configured to support the expression matching processes described in greater detail below. In the illustrated embodiment, the application server 102 includes a first processing system 120 that retrieves or otherwise obtains data items 109 from the third-party system(s) 108 via the network 112 and provides obtained data items to a second processing system 122 that attempts to match the obtained data items to expressions stored or otherwise maintained by a data storage element 124 (or memory). In exemplary embodiments, the second processing system 122 is realized as a graphics processing unit (GPU) that is optimized for performing processing tasks in parallel, however, it should be noted that the subject matter described herein is not limited to use with GPUs, and in practice, the second processing system 122 may be realized using any suitable processing system optimized for performing processing tasks in parallel. That said, for convenience, but without limitation, the second processing system 122 may alternatively be referred to herein as a GPU. The GPU 122 includes or otherwise accesses a non-transitory computer-readable medium capable of storing programming instructions for execution that, when read and executed, cause the GPU 122 to generate an expression matching engine 121 that obtains data items 109 from the first processing system 120, obtains expressions from the memory 124, and performs various additional tasks, operations, functions, and processes to match expressions to data items as described in greater detail below in the context of FIG. 2. In exemplary embodiments, the GPU 122 provides any data items that are matched to one or more expressions back to the first processing system 120 for further processing and/or ingestion while any data items that do not match any expressions are discarded, deleted, or otherwise excluded from further processing and/or ingestion. The first processing system 120 may be implemented using any suitable processing system, such as one or more processors, controllers, microprocessors, microcontrollers, processing cores and/or other computing resources configured to support the operation of the first processing system 120 described herein. Accordingly, for convenience, the first processing system 120 may alternatively be referred to herein as a central processing unit (CPU). The CPU 120 also includes or otherwise accesses a non-transitory computer-readable medium capable of storing programming instructions for execution that, when read and executed, cause the CPU 120 to generate an ingestion engine 123 that obtains data items 109 from the third-party system(s) 108, receives matched data items 109 along with indications of their matching expressions from the expression matching engine 121, and stores information pertaining to the matched data items 109 and their matched expressions in the database 104.

In the illustrated embodiment, the CPU 120 also provides an application platform 126 that generates or otherwise provides a virtual application 128 at run-time (e.g., or “on-demand”) based upon data stored or otherwise maintained by the database 104, and the virtual application 128 is provided to a client device 110 via the network 112 and allows the user of the client device 110 to create, delete, or otherwise modify expressions maintained in memory 124 that are associated with the user, or alternatively, to view or otherwise analyze the data items 109 that match one or more expressions associated with the user. In this regard, the client device 110 generally represents an electronic device coupled to the network 112 that is utilized by the user to access the application platform 126 and/or virtual application 128 on the application server 102. In practice, the client device 110 can be realized as any sort of personal computer, mobile telephone, tablet or other network-enabled electronic device that includes a display device, such as a monitor, screen, or another conventional electronic display, capable of graphically presenting data and/or information provided by the application platform 126 and/or the virtual application 128 along with a user input device, such as a keyboard, a mouse, a touchscreen, or the like, capable of receiving input data and/or other information from the user of the client device 110. In the illustrated embodiment, the user manipulates the client device 110 to execute a client application 111, such as a web browser application, and contact the application server 102 and/or application platform 126 using a networking protocol, such as the hypertext transport protocol (HTTP) or the like. The application platform 126 authenticates or otherwise identifies the user and generates the virtual application 128 at run-time based upon information and/or data associated with the user maintained by the database 104 and/or memory 124. In this regard, the virtual application 128 includes code, data and/or other dynamic web content provided to the client device 110 that can be parsed, executed or otherwise presented by the client application 111 running on the client device 110. The virtual application 128 may provide graphical user interface (GUI) displays that include GUI elements adapted to allow the user to add, create, or otherwise define expressions to be monitored which may be stored in the memory 124 and associated with the user. After the user has defined the expressions the user would like the third-party system(s) 108 to be monitored for, the virtual application 128 may provide GUI displays that present or otherwise provide information pertaining to the identified data items 109 obtained from the third-party system(s) 108 that match one or more of the expressions associated with the user of the client device 110 based on the information pertaining to those matched data items 109 that is stored or otherwise maintained in the database 104. For example, the virtual application 128 and/or application platform 126 may periodically poll the database 104 for recent entries for data items 109 obtained from the third-party system(s) 108 that are associated with an expression identifier that matches an expression identifier for an expression that was defined by or is otherwise associated with the user of the client device 110.

In the illustrated embodiment of FIG. 1, the third-party system(s) 108 generally represent one or more web servers or other computer systems communicatively coupled to the network 112 that provide, host, publish, or otherwise make accessible data items 109 for viewing or other consumption over the network 112. In this regard, data items 109 provided by a respective third-party system 108 may be associated with a unique location on the network 112 associated with that third-party system 108, such as, for example, a uniform resource locator (URL) for the location of a respective data item 109 on that third party's domain. In exemplary embodiments, the third-party system(s) 108 comprise social media websites and/or web servers that host or otherwise provide posts, articles, messages, and the like, which are publicly accessible over the network 112. In exemplary embodiments, the ingestion engine 123 includes a web crawler or similar functionality, which accesses the third-party system(s) 108 to obtain data items 109 substantially in real-time with respect to their publication on by the third-party system(s) 108 and maintains or otherwise provides a queue of recently published data items 109, wherein the expression matching engine 121 obtains these data items 109 from the ingestion engine 123 and attempts to match them to the expressions maintained in memory 124, as described in greater detail below in the context of FIG. 2.

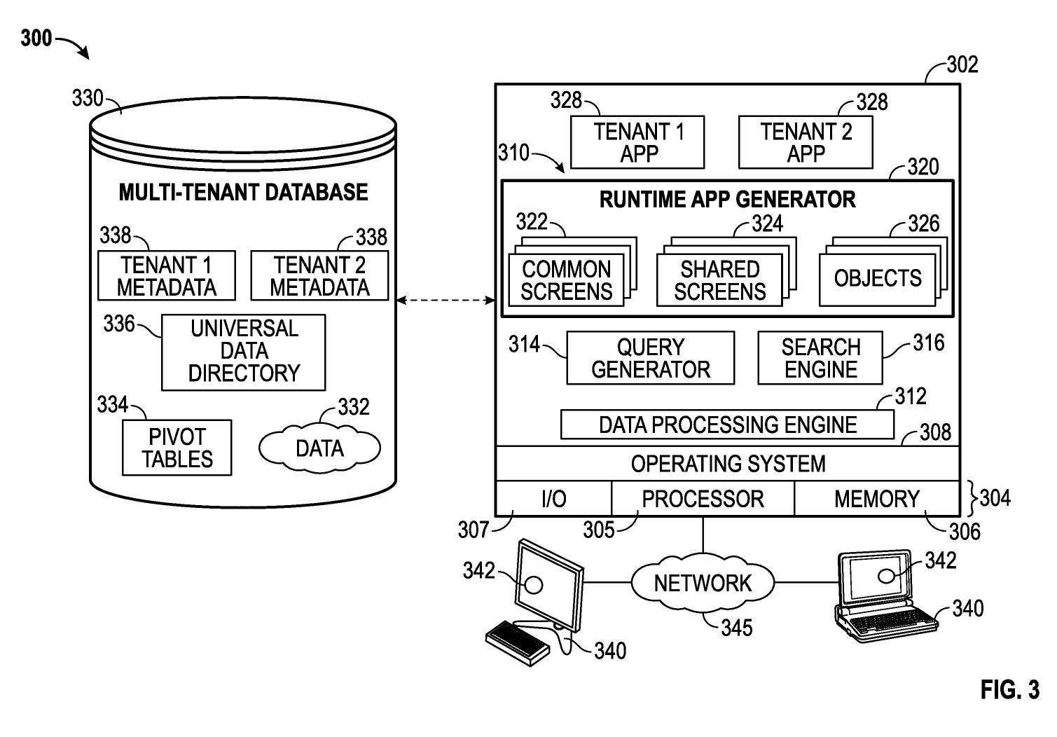

Still referring to FIG. 1, in accordance with one or more embodiments, the database 104 is realized as a relational multi-tenant database that as part of a multi-tenant system 105. In this regard, the application server 102 may be associated with or otherwise assigned a unique tenant identifier, such that information pertaining to matched data items 109 identified and provided by the application server 102 is stored in association with that unique tenant identifier. As described in greater detail below in the context of FIG. 3, the multi-tenant system 105 that includes a multi-tenant application server 106 coupled to the network 112 that includes or otherwise implements an application platform 107 that interfaces between the multi-tenant database 104 and the ingestion engine 123 and/or application platform 126 to store and/or retrieve information pertaining to matched data items 109 and their matched expressions to/from the database 104. However, it should be noted that the subject matter described herein is not intended to be limited to use with multi-tenant systems. For example, in some embodiments, the application server 102 may include or otherwise communicate directly with the database 104, in which case the application server 102 need not rely on the network 112 and/or the multi-tenant application server 106 to store and/or retrieve information to/from the database 104.

FIG. 2 depicts an exemplary embodiment of an expression matching process 200 suitable for implementation by an expressing matching system, such as expression matching system 100, to identify individual data items that match one or more individual expressions. The various tasks performed in connection with the illustrated process 200 may be performed by software, hardware, firmware, or any combination thereof. For illustrative purposes, the following description may refer to elements mentioned above in connection with FIG. 1. In practice, portions of the expression matching process 200 may be performed by different elements of the expression matching system 100, such as, for example, the application server 102, the GPU 122, the CPU 120, the expression matching engine 121, the ingestion engine 123, the application platform 126, the multi-tenant application server 106 and/or the multi-tenant application platform 107. It should be appreciated that the expression matching process 200 may include any number of additional or alternative tasks, the tasks need not be performed in the illustrated order and/or the tasks may be performed concurrently, and/or the expression matching process 200 may be incorporated into a more comprehensive procedure or process having additional functionality not described in detail herein. Moreover, one or more of the tasks shown and described in the context of FIG. 2 could be omitted from a practical embodiment of the expression matching process 200 as long as the intended overall functionality remains intact.

Referring to FIG. 2, and with continued reference to FIG. 1, in an exemplary embodiment, the expression matching process 200, in an exemplary embodiment, the expression matching process 200 begins by calculating or otherwise determining a desired number of partitioning stages and a corresponding number of data items per subset for each partitioning stage to achieve a desired reduction in the total number of individual comparisons for matching the entire set of expressions being monitored to data items based on the total number of expressions being monitored (task 202). As described below, data items obtained from the third-party system(s) 108 are partitioned into subsets (or partitions) of smaller and smaller sizes to identify expression subsets having a reduced number of expressions relative to the total number of expressions being monitored, and thereby reduce the number of times expressions of the expression set are individually compared to individual data items that do not match the expression. In other words, the expression set is pruned so that fewer individual comparisons that do not result in a match between an individual data item and an individual expression are performed. As described in greater detail below, based at least in part on the total number of expressions maintained in the memory 124 and an expected (or empirically estimated) number of expressions that will be matched to the subsets of each partitioning stage based on the number of data items per subset, the expression matching process 200 calculates, determines, or otherwise identifies the number of partitioning stages to be utilized to achieve a desired reduction in the number of comparisons and the number of data items per subset for each partitioning stage that maximizes the reduction in the number of comparisons for that number of partitioning stages. In this regard, the number of partitioning stages and their corresponding data item subset sizes may be dynamically determined throughout operation of the expression matching system 100, such as, for example, in response to changes to the number of expressions maintained in the memory 124.

In an exemplary embodiment, the expression matching process 200 continues by obtaining data items from one or more third-party system(s) and partitioning or otherwise dividing the obtained data items into a plurality of subsets having the number of data items per subset for the first partitioning stage (tasks 204, 206). As described above, the ingestion engine 123 includes a web crawler that accesses the third-party system(s) 108 to obtain and create a queue of recently published data items 109 that is provided to or otherwise accessed by the expression matching engine 121. The expression matching engine 121 obtains a fixed number of data items from the queue maintained by the ingestion engine 123 and initially partitions or otherwise divides those obtained data items 109 into subsets or groups that have the previously determined number of data items 109 corresponding to the first partitioning stage. In this regard, after partitioning, each data item subset of the partitioning stage has substantially the same number of data items as the other data item subsets created by the partitioning, however, each data item subset includes data items that are different from those contained by the other data item subsets. In other words, the data item subsets are distinct and do not overlap or otherwise have any data items in common with one another. As described in greater detail below, the number of data items per subset for the first partitioning stage may be optimized to minimize the total number of individual comparisons required for the expression matching process 200.

In an exemplary embodiment, the expression matching process 200 continues by obtaining a positive set of expressions that corresponds to the full set of expressions being monitored (task 208). In this regard, the positive set of expressions contains all of the expressions maintained in memory 124 but with any excluded keywords or terms (e.g., keywords or terms joined to the remainder of the expression by an excluding operator) being removed from the expressions. In other words, any expression that includes excluded or negated terms is converted to a purely positive expression by removing those terms joined to the remainder of the expression by an excluding operator (e.g., ‘NOT’ or the like). For example, for an expression of “brand AND product name NOT free,” for the positive set of expressions, the expression is reduced to “brand AND product name.”

After the positive expression set is obtained, the expression matching process 200 continues by identifying, for each respective data item subset, a subset of that expression set that matches that respective data item subset (task 210). In this regard, each expression of the expression set (neglecting any excluded terms) is collectively compared to an entire data item subset to determine whether there might be a data item that matches that expression within the data item subset, thereby effectively partitioning the expression set by removing or otherwise disregarding expressions that do not have a potential match within the data item subset from unnecessary further comparisons. For example, the data items of the subset may be collectively compared to each expression by combining the data items or otherwise concatenating the text of the data items to obtain a combined data item string of text. Each expression may then be compared against the combination of data items of the data item subset collectively using the Aho-Corasick string matching algorithm or another suitable matching algorithm to determine whether the combined data item string of text matches or otherwise includes that respective expression. When the result of the comparison is true or otherwise indicates that the data item subset includes a respective expression, the expression matching engine 121 identifies that respective expression as having a potential match within the data item subset and adds that expression to the expression subset that corresponds to that data item subset (e.g., by storing or otherwise maintaining the identifier associated with that respective expression in association with the data item subset). In this manner, for each data item subset, the expression matching engine 121 identifies a subset of the full expression set that contains only those expressions that have a potential match within the respective data item subset. In other words, the identified expression subset contains expressions that matched the respective data item subset collectively. As described in greater detail below, when a respective data item subset is further partitioned in to child data item subsets, the identified expression subset functions a parent expression subset that is compared to each child data item subset collectively to identify a child subset of the parent expression subset that contains only those expressions of the parent expression subset that match the respective child data item subset collectively.

Still referring to FIG. 2, in exemplary embodiments, the expression matching process 200 continues by determining whether the subsets of data items should be further partitioned or otherwise subdivided, and if so, the expression matching process 200 proceeds to subdivide each respective data item subset into a plurality of additional data items subsets having a lesser number of data items per subset (tasks 212, 214). In this regard, when the expression matching engine 121 determines the desired number of partitioning stages have not been performed, the expression matching engine 121 further subdivides each data item subset of a previous partitioning stage into further subsets having the previously determined number of data items corresponding to that next partitioning stage. In this manner, the expression matching engine 121 further reduces each parent data item subset from a previous partitioning stage into a plurality of child data item subsets having fewer data items per subset. In a similar manner as set forth above, after the partitioning, each child data item subset has substantially the same number of data items as the other child data item subsets created by the partitioning, however, each child data item subset includes data items that are different from those contained by the other child data item subsets.

After partitioning a parent data item subset into child data item subsets, the expression matching process 200 continues by identifying, for each respective child data item subset, a further subset of the expression subset that collectively matched the parent data item subset that contains only expressions that match the respective child data item subset collectively (task 216). In this regard, each child data item subset is collectively compared to each expression of a parent expression subset that matched its parent data item subset to determine whether there might be a data item that matches that respective expression within the child data item subset. For example, another combined data item string may be created by concatenating or otherwise combining data items of the child data item subset, and each expression of the parent expression subset may be compared to the combined data item string using the Aho-Corasick string matching algorithm or another suitable matching algorithm to determine whether the combined data item string of text matches or otherwise includes that respective expression. As described above, when the result of the comparison is true or otherwise indicates that a child data item subset includes a respective expression, the expression matching engine 121 identifies that respective expression as having a potential match within the respective child data item subset and adds that expression to the child expression subset for that child data item subset (e.g., by storing or otherwise maintaining the identifier associated with that respective expression in association with the child data item subset). Thus, the child expression subset corresponding to a child data item subset contains only those expressions of the parent expression subset that collectively matched the child data item subset.

In exemplary embodiments, the loop defined by tasks 212, 214 and 216 repeats until the desired number of partitioning stages have been performed. After the desired number of partitioning stages have been performed, the expression matching process 200 continues by obtaining, for each child data item subset, the full expressions corresponding to the respective child expression subset that collectively matched that respective child data item subset (task 218). For example, using the identifiers associated with the expressions of a child expression subset, the expression matching engine 121 obtains the corresponding expressions from the memory 124 that include any excluded or negated terms that were previously removed from those expressions for the preceding partitioning stages (e.g., task 208). After obtaining the full expressions for the respective child expression subset that collectively matched a respective child data item subset, the expression matching process 200 continues by individually comparing individual data items of that child data item subset to each of the individual full expressions of that child expression subset set to identify each individual data item that matches or otherwise includes one or more of the expressions (task 220). In this regard, each individual data item of the child data item subset is individually compared against each individual expression of the child expression subset using the Aho-Corasick string matching algorithm or another suitable matching algorithm to determine whether that respective data item matches that respective expression. When the result of the comparison is true or otherwise indicates that a respective expression matches a respective data item within the child data item subset, the expression matching engine 121 stores or otherwise maintains the identifier associated with that respective expression in association with that respective data item, thereby maintaining an association between each matching data item and the corresponding expressions in memory 124 that it matches.

After individually comparing the data items of the child data item subset to the expressions of the child expression subset for all of the child data item subsets and corresponding child expression subsets, the expression matching process 200 continues ingesting the matching data items (task 222). For example, the expression matching engine 121 may provide the matched data items (or information pertaining thereto) to the ingestion engine 123 along with identification of the respective expressions that were matched to each matching data item for further ingestion and/or processing. In exemplary embodiments, the ingestion engine 123 interfaces with the multi-tenant application platform 107 (e.g., using application programming interfaces (APIs) supported by the application platform 107) to index and store or otherwise maintain information pertaining to each matching data item along with identification of its matching expressions in the multi-tenant database 104, while data items that were not matched to any expressions are discarded or otherwise removed from indexing and/or further processing. Subsequently, when the virtual application 128 polls the multi-tenant database 104 for data items that match expressions associated with the user of the client device 110, the content of those matching data items and/or their matching expressions may be retrieved from the database 104 and presented on the client device 110 by the virtual application 128, thereby providing indication of the matching data items and apprising the user of the client device 110 of recent activity on the third-party system(s) 108 that satisfy one or more of the user's expressions being monitored. By virtue of the partitioning of the data items and expressions into corresponding subsets, the total number of individual comparisons (e.g., task 220) are reduced. As a result, the delay between the time an activity involving an expression being monitored by the user of the client device 110 occurs on the third-party system(s) 108 (e.g., the generation or publication of a matching data item) and the time at which indication of the activity is provided or otherwise displayed on the client device 110 (e.g., by presenting the communications or content of the matched data items) is reduced, such that the user of the client device 110 is apprised of the activity at or near real-time.

As described above, the number of partitioning stages may be increased to reduce the total number of individual comparisons performed by the expression matching process 200, and the number of data items per subset per partitioning stage may be optimized to achieve the greatest reduction in individual comparisons based on the number of partitioning stages and the total number of expression in the full expression set. In this regard, the number of comparisons per each partitioning stage may be modeled as the total number of data items divided by the number of data items in the data item subset for that partitioning stage and multiplied by the number of expressions against which that data item subset will be matched. The first partitioning stage must match the data item subsets against the full expression set, while the number of expressions matched against a subsequent (or child) partitioning stage may be estimated or otherwise modeled as a function of the number of the number of data items in the data item subsets of the previous (or parent) partitioning stage and the number of expressions being compared to the previous partitioning stage. In this regard, the coefficients, variables and/or other parameters of the function may be empirically determined such that the outcome of evaluating the empirical function for a given number of data items in parent data item subset and the number of expressions being compared to the parent data item subset corresponds to the expected number of expressions likely to be matched to the parent data item subset.

To identify the optimal number of data items per partitioning stage, the total number of individual comparisons performed by the expression matching process 200 is modeled as a sum of the number of the comparisons for the individual partitioning stages and minimized assuming a single data item per subset in the final partitioning stage (for fine comparisons between each individual data item and each of the remaining expressions of its corresponding child expression subset). For example, an estimated total number of comparisons may be represented by

$${c}_{T , n} = {\sum }_{i = 1}^{n} {c}_{i} ,$$

where cᵢ represents a vector of the number of comparisons per partitioning stage, which is represented by

$$\frac{d}{{b}_{i}} \times e$$

for i=1 and

$$\frac{d}{{b}_{i}} \times E ( {b}_{i - 1} )$$

for i>1, where d is the number of data items obtained at one time from the queue provided by the ingestion engine 123, bᵢ is the number of data items per data item subset for that respective partitioning stage, e is the total number of expressions in the full expression set maintained by memory 124, and E(bᵢ₋₁) is the expected (or empirically estimated) number of expressions that will be compared to the data item subsets of that partitioning stage (e.g., the number of expressions likely to be matched to the parent data item subset of the child data item subsets of that partitioning stage). The estimated total number of comparisons is then minimized by setting bₙ=1 (for fine comparisons between each individual data item and each of the remaining expressions of its corresponding child expression subset) and identifying optimal values for bᵢ for 1≦i≦n−1 that result in the minimum value of c_{T}. For example, for a total number of data items (d) obtained from the ingestion engine 123 equal to 1,000,000, a total number of expressions (e) maintained in memory 124 equal to 566,000, and a quadratic empirical function of E(bᵢ₋₁)=0.000959×bᵢ₋₁²+0.534×bᵢ₋₁−0.102, the optimal values for the data item subset sizes may be determined to be: 584 and 1 for two partitioning stages for a reduction in total comparisons by a factor of about 351 relative to the number of comparisons that would result if an exhaustive matching scheme were utilized (or 1/351 the number of comparisons for exhaustive matching); 3221, 123 and 1 for three partitioning stages for a reduction in total comparisons by a factor of about 1613; 8743, 2337, 351, 23 and 1 for five partitioning stages with a reduction in comparisons by a factor of about 3969; and 10986, 4610, 1638, 432, 73, 8 and 1 for seven partitioning stages with a reduction in total comparisons by a factor of about 4916. In this regard, the total number of comparisons required by the expression matching process 200 may be reduced to a more logarithmic order (e.g., O(d×log e)) as opposed to being proportional to the number of expressions (e.g., O(d×e)). As the number of expressions (e) in the expression set increases, the number of partitioning stages may be increased to achieve the desired reduction in comparisons.

FIG. 3 depicts an exemplary embodiment of a multi-tenant system 300 suitable for use as the multi-tenant system 105 in the expression matching system 100 of FIG. 1. The illustrated multi-tenant system 300 of FIG. 3 includes a server 302 (e.g., application server 106) that dynamically creates and supports virtual applications 328 based upon data 332 from a common database 330 (e.g., database 104) that is shared between multiple tenants, alternatively referred to herein as a multi-tenant database. Data and services generated by the virtual applications 328 are provided via a network 345 (e.g., network 112) to any number of client devices 340 (e.g., application server 102, client device 110, or the like), as desired. Each virtual application 328 is suitably generated at run-time (or on-demand) using a common application platform 310 (e.g., application platform 107) that securely provides access to the data 332 in the database 330 for each of the various tenants subscribing to the multi-tenant system 300. In accordance with one non-limiting example, the multi-tenant system 300 is implemented in the form of an on-demand multi-tenant customer relationship management (CRM) system that can support any number of authenticated users of multiple tenants.

As used herein, a “tenant” or an “organization” should be understood as referring to a group of one or more users that shares access to common subset of the data within the multi-tenant database 330. In this regard, each tenant includes one or more users associated with, assigned to, or otherwise belonging to that respective tenant. To put it another way, each respective user within the multi-tenant system 300 is associated with, assigned to, or otherwise belongs to a particular tenant of the plurality of tenants supported by the multi-tenant system 300. Tenants may represent customers, customer departments, business or legal organizations, and/or any other entities that maintain data for particular sets of users within the multi-tenant system 300. For example, the application server 102 may be associated with one tenant supported by the multi-tenant system 300. Although multiple tenants may share access to the server 302 and the database 330, the particular data and services provided from the server 302 to each tenant can be securely isolated from those provided to other tenants. The multi-tenant architecture therefore allows different sets of users to share functionality and hardware resources without necessarily sharing any of the data 332 belonging to or otherwise associated with other tenants.

The multi-tenant database 330 is any sort of repository or other data storage system capable of storing and managing the data 332 associated with any number of tenants. The database 330 may be implemented using any type of conventional database server hardware. In various embodiments, the database 330 shares processing hardware 304 with the server 302. In other embodiments, the database 330 is implemented using separate physical and/or virtual database server hardware that communicates with the server 302 to perform the various functions described herein. In an exemplary embodiment, the database 330 includes a database management system or other equivalent software capable of determining an optimal query plan for retrieving and providing a particular subset of the data 332 to an instance of virtual application 328 in response to a query initiated or otherwise provided by a virtual application 328. The multi-tenant database 330 may alternatively be referred to herein as an on-demand database, in that the multi-tenant database 330 provides (or is available to provide) data at run-time to on-demand virtual applications 328 generated by the application platform 310.

In practice, the data 332 may be organized and formatted in any manner to support the application platform 310. In various embodiments, the data 332 is suitably organized into a relatively small number of large data tables to maintain a semi-amorphous “heap”-type format. The data 332 can then be organized as needed for a particular virtual application 328. In various embodiments, conventional data relationships are established using any number of pivot tables 334 that establish indexing, uniqueness, relationships between entities, and/or other aspects of conventional database organization as desired. Further data manipulation and report formatting is generally performed at run-time using a variety of metadata constructs. Metadata within a universal data directory (UDD) 336, for example, can be used to describe any number of forms, reports, workflows, user access privileges, business logic and other constructs that are common to multiple tenants. Tenant-specific formatting, functions and other constructs may be maintained as tenant-specific metadata 338 for each tenant, as desired. Rather than forcing the data 332 into an inflexible global structure that is common to all tenants and applications, the database 330 is organized to be relatively amorphous, with the pivot tables 334 and the metadata 338 providing additional structure on an as-needed basis. To that end, the application platform 310 suitably uses the pivot tables 334 and/or the metadata 338 to generate “virtual” components of the virtual applications 328 to logically obtain, process, and present the relatively amorphous data 332 from the database 330.

The server 302 is implemented using one or more actual and/or virtual computing systems that collectively provide the dynamic application platform 310 for generating the virtual applications 328. For example, the server 302 may be implemented using a cluster of actual and/or virtual servers operating in conjunction with each other, typically in association with conventional network communications, cluster management, load balancing and other features as appropriate. The server 302 operates with any sort of conventional processing hardware 304, such as a processor 305, memory 306, input/output features 307 and the like. The input/output features 307 generally represent the interface(s) to networks (e.g., to the network 345, or any other local area, wide area or other network), mass storage, display devices, data entry devices and/or the like. The processor 305 may be implemented using any suitable processing system, such as one or more processors, controllers, microprocessors, microcontrollers, processing cores and/or other computing resources spread across any number of distributed or integrated systems, including any number of “cloud-based” or other virtual systems. The memory 306 represents any non-transitory short or long term storage or other computer-readable media capable of storing programming instructions for execution on the processor 305, including any sort of random access memory (RAM), read only memory (ROM), flash memory, magnetic or optical mass storage, and/or the like. The computer-executable programming instructions, when read and executed by the server 302 and/or processor 305, cause the server 302 and/or processor 305 to create, generate, or otherwise facilitate the application platform 310 and/or virtual applications 328 and perform one or more additional tasks, operations, functions, and/or processes described herein. It should be noted that the memory 306 represents one suitable implementation of such computer-readable media, and alternatively or additionally, the server 302 could receive and cooperate with external computer-readable media that is realized as a portable or mobile component or application platform, e.g., a portable hard drive, a USB flash drive, an optical disc, or the like.

The application platform 310 is any sort of software application or other data processing engine that generates the virtual applications 328 that provide data and/or services to the client devices 340. In a typical embodiment, the application platform 310 gains access to processing resources, communications interfaces and other features of the processing hardware 304 using any sort of conventional or proprietary operating system 308. The virtual applications 328 are typically generated at run-time in response to input received from the client devices 340. For the illustrated embodiment, the application platform 310 includes a bulk data processing engine 312, a query generator 314, a search engine 316 that provides text indexing and other search functionality, and a runtime application generator 320. Each of these features may be implemented as a separate process or other module, and many equivalent embodiments could include different and/or additional features, components or other modules as desired.

The runtime application generator 320 dynamically builds and executes the virtual applications 328 in response to specific requests received from the client devices 340. The virtual applications 328 are typically constructed in accordance with the tenant-specific metadata 338, which describes the particular tables, reports, interfaces and/or other features of the particular application 328. In various embodiments, each virtual application 328 generates dynamic web content that can be served to a browser or other client program 342 associated with its client device 340, as appropriate.

The runtime application generator 320 suitably interacts with the query generator 314 to efficiently obtain multi-tenant data 332 from the database 330 as needed in response to input queries initiated or otherwise provided by users of the client devices 340. In a typical embodiment, the query generator 314 considers the identity of the user requesting a particular function (along with the user's associated tenant), and then builds and executes queries to the database 330 using system-wide metadata 336, tenant specific metadata 338, pivot tables 334, and/or any other available resources. The query generator 314 in this example therefore maintains security of the common database 330 by ensuring that queries are consistent with access privileges granted to the user and/or tenant that initiated the request. In this manner, the query generator 314 suitably obtains requested subsets of data 332 accessible to a user and/or tenant from the database 330 as needed to populate the tables, reports or other features of the particular virtual application 328 for that user and/or tenant.

Still referring to FIG. 3, the data processing engine 312 performs bulk processing operations on the data 332 such as uploads or downloads, updates, online transaction processing, and/or the like. In many embodiments, less urgent bulk processing of the data 332 can be scheduled to occur as processing resources become available, thereby giving priority to more urgent data processing by the query generator 314, the search engine 316, the virtual applications 328, etc.

In exemplary embodiments, the application platform 310 is utilized to create and/or generate data-driven virtual applications 328 for the tenants that they support. Such virtual applications 328 may make use of interface features such as custom (or tenant-specific) screens 324, standard (or universal) screens 322 or the like. Any number of custom and/or standard objects 326 may also be available for integration into tenant-developed virtual applications 328. As used herein, “custom” should be understood as meaning that a respective object or application is tenant-specific (e.g., only available to users associated with a particular tenant in the multi-tenant system) or user-specific (e.g., only available to a particular subset of users within the multi-tenant system), whereas “standard” or “universal” applications or objects are available across multiple tenants in the multi-tenant system. The data 332 associated with each virtual application 328 is provided to the database 330, as appropriate, and stored until it is requested or is otherwise needed, along with the metadata 338 that describes the particular features (e.g., reports, tables, functions, objects, fields, formulas, code, etc.) of that particular virtual application 328. For example, a virtual application 328 may include a number of objects 326 accessible to a tenant, wherein for each object 326 accessible to the tenant, information pertaining to its object type along with values for various fields associated with that respective object type are maintained as metadata 338 in the database 330. In this regard, the object type defines the structure (e.g., the formatting, functions and other constructs) of each respective object 326 and the various fields associated therewith.

Still referring to FIG. 3, the data and services provided by the server 302 can be retrieved using any sort of personal computer, mobile telephone, tablet or other network-enabled client device 340 on the network 345. In an exemplary embodiment, the client device 340 includes a display device, such as a monitor, screen, or another conventional electronic display capable of graphically presenting data and/or information retrieved from the multi-tenant database 330. Typically, the user operates a conventional browser application or other client program 342 executed by the client device 340 to contact the server 302 via the network 345 using a networking protocol, such as the hypertext transport protocol (HTTP) or the like. The user typically authenticates his or her identity to the server 302 to obtain a session identifier (“SessionID”) that identifies the user in subsequent communications with the server 302. When the identified user requests access to a virtual application 328, the runtime application generator 320 suitably creates the application at run time based upon the metadata 338, as appropriate. As noted above, the virtual application 328 may contain Java, ActiveX, or other content that can be presented using conventional client software running on the client device 340; other embodiments may simply provide dynamic web or other content that can be presented and viewed by the user, as desired.

To briefly summarize, one advantage of the subject matter described herein is that the total number of individual comparisons performed are reduced, thereby freeing up computational resources for other tasks and reducing the total amount of time required to ingest data items. For example, in the embodiment described above having three partitioning stages and a total number of expressions equal to 566,000, the expression matching engine 121 obtains 1,000,000 data items from the ingestion engine 123, partitions the 1,000,000 data items into subsets having 3221 data items per subset (e.g., task 206) and, for each data item subset, identifies the subset of the 566,000 expressions that collectively match a respective data item subset (e.g., task 210). The expression matching engine 121 continues by partitioning each data item subset into child data item subsets having 123 data items per subset (e.g., tasks 212, 214) and, for each child data item subset, identifies a further subset of the expressions that collectively match a respective child data item subset (e.g., task 216). The expression matching engine 121 obtains the full expressions of the subset that collectively matched a child data item subset (e.g., task 218), and then, for each of the 123 data items in that child data item subset, individually compares the data item to the individual expressions of that expression subset to identify data items that match one or more expressions (e.g., task 220). In this manner, rather than individually comparing each of the 1,000,000 data items to each of the 566,000 expressions, the expression matching engine 121 may individually compares each of the data items only to those expressions in the expression subset that collectively matched the respective child data item subset that respective data item belongs to, thereby reducing the total number of individual comparisons performed by the expression matching engine 121 to match those 1,000,000 data items to the expressions by a factor of about 1613.

The foregoing description is merely illustrative in nature and is not intended to limit the embodiments of the subject matter or the application and uses of such embodiments. Furthermore, there is no intention to be bound by any expressed or implied theory presented in the technical field, background, or the detailed description. As used herein, the word “exemplary” means “serving as an example, instance, or illustration.” Any implementation described herein as exemplary is not necessarily to be construed as preferred or advantageous over other implementations, and the exemplary embodiments described herein are not intended to limit the scope or applicability of the subject matter in any way.

For the sake of brevity, conventional techniques related to web crawling, expression matching, and other functional aspects of the systems (and the individual operating components of the systems) may not be described in detail herein. In addition, those skilled in the art will appreciate that embodiments may be practiced in conjunction with any number of system and/or network architectures, data transmission protocols, and device configurations, and that the system described herein is merely one suitable example. Furthermore, certain terminology may be used herein for the purpose of reference only, and thus is not intended to be limiting. For example, the terms “first”, “second” and other such numerical terms do not imply a sequence or order unless clearly indicated by the context.

Embodiments of the subject matter may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processing systems or devices can carry out the described operations, tasks, and functions by manipulating electrical signals representing data bits at accessible memory locations, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices. When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “processor-readable medium” or “machine-readable medium” may include any non-transitory medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like. In this regard, the subject matter described herein can be implemented in the context of any computer-implemented system and/or in connection with two or more separate and distinct computer-implemented systems that cooperate and communicate with one another. In one or more exemplary embodiments, the subject matter described herein is implemented in conjunction with a virtual customer relationship management (CRM) application in a multi-tenant environment.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application. Accordingly, details of the exemplary embodiments or other limitations described above should not be read into the claims absent a clear intention to the contrary.

What is claimed is:

1. A method of matching a plurality of expressions to a plurality of data items, the method comprising:
identifying a first subset of the plurality of expressions that match the plurality of data items collectively; and
identifying individual data items of the plurality of data items that match one or more expressions of the first subset.

2. The method of claim 1, wherein identifying the first subset of expressions that match the plurality of data items collectively comprises:
combining the plurality of data items to obtain a combined data item; and
comparing each expression of the plurality of expressions to the combined data item to identify one or more expressions of the plurality of expressions that match the combined data item, the first subset comprising the one or more expressions that match the combined data item.

3. The method of claim 2, wherein identifying the individual data items comprises comparing each data item of the plurality of data items to each expression of the first subset to identify the individual data items.

4. The method of claim 1, further comprising:
partitioning the plurality of data items into a plurality of data item subsets; and
for each data item subset, identifying a respective expression subset of the first subset of expressions that matches the respective subset of data items collectively.

5. The method of claim 4, wherein identifying the individual data items comprises individually comparing, for each data item subset, each data item of the respective data item subset to each expression of the respective expression subset that matches the respective data item subset.

6. The method of claim 4, further comprising determining a number of data items per data item subset for the partitioning based at least in part on a total number of expressions for the plurality of expressions, wherein partitioning the plurality of data items comprises dividing the plurality of data items into the plurality of data item subsets having the number of data items.

7. The method of claim 6, wherein determining the number comprises determining the number that minimizes an estimated total number of individual comparisons, the estimated total number being based at least in part on the total number of expressions and a number of partitioning stages.

8. The method of claim 1, further comprising:
partitioning the plurality of data items into a first data item subset; and
identifying a second subset of the first subset of expressions that matches the first data item subset collectively, wherein identifying the individual data items comprises individually comparing each data item of the first data item subset to each expression of the second subset.

9. The method of claim 1, further comprising:
obtaining, by a first processing system, the plurality of data items from one or more third-party systems coupled to a network; and
providing, by the first processing system, the plurality of data items to a graphics processing system, wherein the graphics processing system identifies the individual data items.

10. The method of claim 9, further comprising:
receiving, by the first processing system, the individual data items matched to one or more expressions of the first subset from the graphics processing system; and
storing information pertaining to each individual data item and its one or more matching expressions in a database.

11. A computer-readable medium comprising computer-executable instructions that, when executed by a processing system, cause the processing system to:
partition a plurality of data items into a plurality of data item subsets;
identify for a first data item subset of the plurality of data item subsets, a first expressions subset that matches the first data item subset, the first expressions subset comprising a subset of a plurality of expressions;
partition the first data item subset into a second plurality of data item subsets;
identify, for a second data item subset of the second plurality of data item subsets, a second expressions subset that matches the second data item subset using the first expressions subset, wherein the second expressions subset comprises a subset of the first expressions subset; and
identify individual data items of the second data item subset that match one or more expressions of the second expressions subset.

12. The computer-readable medium of claim 11, wherein the computer-executable instructions cause the processing system to:
compare each expression of the plurality of expressions to a first combination of data items of the first data item subset to identify the subset of plurality of expressions that match the first combination; and
compare each expression of the first expressions subset to a second combination of data items of the second data item subset to identify the subset of the first expressions subset that match the second combination.

13. The computer-readable medium of claim 11, wherein the computer-executable instructions cause the processing system to:
determine a first number of data items per data item subset for a first partitioning stage;
partition the plurality of data items into the plurality of data item subsets by dividing the plurality of data items into data item subsets having the first number;
determine a second number of data items per data item subset for a second partitioning stage, the second number being less than the first number; and
partition the first data item subset into the second plurality of data item subsets by dividing the first data item subset into data item subsets having the second number.

14. A server comprising:
a data storage element to maintain a plurality of expressions;
a first processing system to obtain a plurality of data items via a network; and
a second processing system coupled to the first processing system and the data storage element to identify a first expressions subset comprising one or more expressions of the plurality of expressions that match the plurality of data items, identify individual data items of the plurality of data items that match one or more expressions of the first expressions subset, and provide the individual data items to the second processing system.

15. The server of claim 14, wherein the second processing system identifies the individual data items that match one or more expressions of the first expressions subset by individually comparing each data item of the plurality of data items to each expression of the first expressions subset.

16. The server of claim 14, wherein the second processing system identifies the first expressions subset by combining data items of the plurality of data items to obtain a combined data item and individually comparing each expression of the plurality of expressions to the combined data item.

17. The server of claim 14, wherein the second processing system is configured to partition the plurality of data items into a first data item subset having fewer data items than the plurality of data items, identify a second expressions subset comprising one or more expressions of the first expressions subset that match the first data item subset, and identify the individual data items by individually comparing each data item of the first data item subset to each expression of the second expressions subset.

18. The server of claim 14, wherein the second processing system comprises a graphics processing unit.

19. The server of claim 14, wherein the first processing system is configured to store information pertaining to the individual data items and their matching expressions in a database coupled to the server via the network.

20. The server of claim 19, wherein the first processing system is configured to provide indication of the individual data items to a client device coupled to the server over the network.
